(19) United States
(12) Patent Application Publication
(10) Pub. No.: US 2020/0371692 A1
(43) Pub. Date: Nov. 26, 2020

(54) MEMORY DISAGGREGATION FOR COMPUTE NODES

(71) Applicant: Microsoft Technology Licensing, LLC, Redmond, WA (US)

(72) Inventors: Leendert Peter VAN DOORN, Austin, TX (US); Jeremiah Samir SAMLI, Kirkland, WA (US); Siamak TAVALLAEI, Spring, TX (US)

(73) Assignee: Microsoft Technology Licensing, LLC, Redmond, WA (US)

(21) Appl. No.: 16/529,672

(22) Filed: Aug. 1, 2019

Related U.S. Application Data
(60) Provisional application No. 62/851,287, filed on May 22, 2019.

(51) Int. Cl. G06F 3/06; G06F 9/455

(52) U.S. Cl. CPC G06F 3/067; G06F 3/0604; G06F 2009/45583; G06F 3/0631; G06F 9/45558

(57) ABSTRACT

A disaggregated memory system includes a plurality of compute nodes, each including at least one local memory device configured to fulfill at least some of a plurality of memory read requests and memory write requests for the compute node. A disaggregated memory pool includes a plurality of memory devices each physically separate from the plurality of compute nodes. The disaggregated memory pool is configured to supplement the at least one local memory device of each of the plurality of compute nodes by fulfilling at least some of the plurality of memory read requests and memory write requests of each of the plurality of compute nodes at any particular memory device of the disaggregated memory pool. An amount of memory collectively allocated to the plurality of compute nodes exceeds an amount of memory collectively provided by the plurality of memory devices.

### CROSS REFERENCE TO RELATED APPLICATIONS

This application claims priority to U.S. Provisional Patent Application Ser. No. 62/851,287, filed May 22, 2019, the entirety of which is hereby incorporated herein by reference for all purposes.

### BACKGROUND

Data centers typically include large numbers of discrete compute nodes, such as server computers or other suitable computing devices. Such devices may work independently and/or cooperatively to fulfill various computational workloads.

### BRIEF DESCRIPTION OF THE DRAWINGS

FIG. 1 schematically depicts a plurality of example compute nodes.

FIG. 2 schematically depicts an example data center including a plurality of compute nodes and disaggregated resource pools.

FIGS. 3 and 4 schematically illustrate disaggregation of memory resources.

FIG. 5 schematically shows an example computing system.

### DETAILED DESCRIPTION

As discussed above, data centers typically include large numbers of discrete compute nodes, such as server computers or other suitable computing devices. Depending on the specific implementation, each individual compute node may have any suitable collection of computer hardware. For instance, traditional servers may each be substantially self-sufficient, including processing resources, data storage, volatile/non-volatile memory, network interface componentry, a power supply, a cooling solution, etc. By contrast, some “blade servers” omit internal power supplies, cooling systems, and/or network interfaces, instead relying on a central rack to provide such infrastructure-type functionality for each of a cluster of individual blade servers plugged into the rack.

Regardless, each individual compute node will typically include some local collection of hardware resources, including data storage, memory, processing resources, etc. However, computational workloads (e.g., associated with data center customers) are often not uniformly distributed between each of the compute nodes in the data center. Rather, in a common scenario, a subset of compute nodes in the data center may be tasked with resource-intensive workloads, while other compute nodes sit idle or handle relatively less resource-intensive tasks. Thus, the total resource utilization of the data center may be relatively low, and yet completion of some workloads may be resource-constrained due to how such workloads are localized to individual compute nodes. This represents an inefficient use of the available computer resources, and is sometimes known as “resource stranding,” as computer resources that could potentially be applied to computing workloads are instead stranded in idle or underutilized compute nodes.

Accordingly, the present disclosure is directed to techniques for disaggregation of hardware resources. In an example scenario, each individual compute node in a rack, cluster, or other grouping of compute nodes may share access to a common pool of one or more computer resources that would ordinarily be fully distributed between the various compute nodes. In an example scenario, each compute node (e.g., blade server) in a rack may share access to a volatile memory or storage class memory pool, such that if a particular compute node runs low on local memory, it can consume additional remote memory from a common memory pool. Furthermore, the amount of memory on each compute node may be reduced (e.g., to increase local memory utilization) while leveraging a remote memory pool (e.g., to reduce memory stranding), potentially in conjunction with “thin provisioning,” as will be described in more detail below. In this manner, the total amount of memory available in the data center (and thus the amount of money required to procure and maintain such memory) is substantially lower while maintaining high availability via a fault tolerant system. Remote memory pooling helps alleviate resource stranding, as unused resources are no longer locked away on individual compute nodes. Rather, each individual compute node has access to a shared pool of memory when additional memory capacity is required.

The present disclosure primarily focuses on disaggregation of memory. However, it will be understood that any suitable computer resources of a compute node, including data storage, volatile memory, non-volatile memory, and/or processing acceleration resources, may be disaggregated in this manner. In other words, a group of individual compute nodes may share access to common pools of volatile memory, non-volatile memory, data storage hardware, and/or processing acceleration hardware (e.g., Graphics Processing Units (GPUs), Field Programmable Gate Arrays (FPGAs) Application-Specific Integrated Circuits (ASICs)). This can further alleviate the issues described above with respect to resource stranding, as disaggregation allows a greater portion of the total computer resources in the data center to be used as-needed for any particular workload, rather than isolated to individual compute nodes that may or may not be fully in use at any given time.

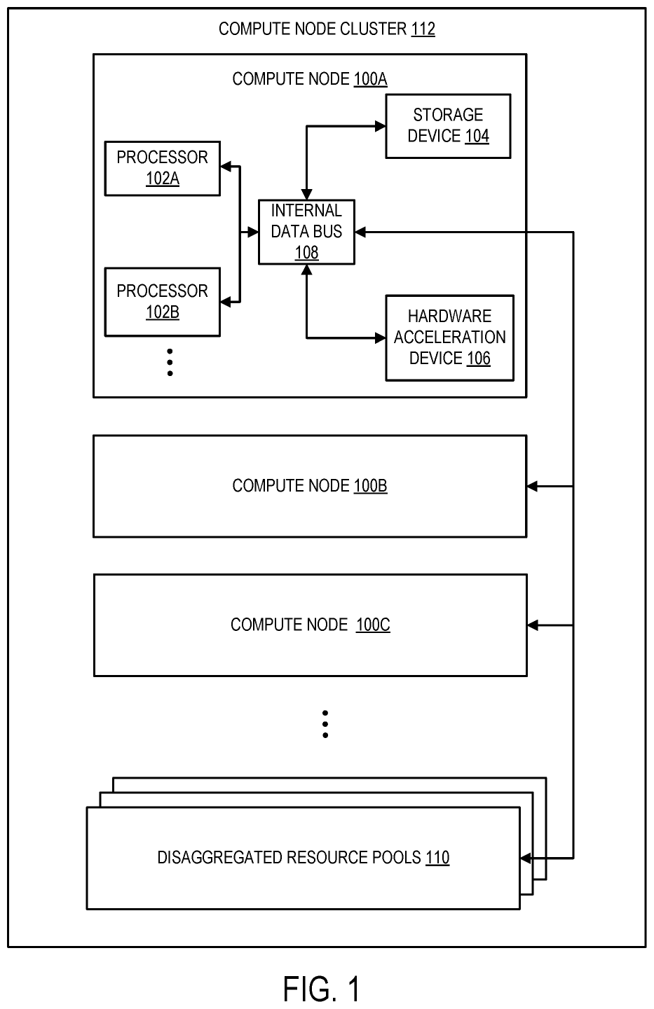

FIG. 1 schematically depicts a plurality of example compute nodes, including nodes 100A-100C. As shown, each compute node may include one or more processors 102 (e.g., a central processing unit (CPU)); one or more storage devices 104, including volatile and/or non-volatile data storage; one or more hardware acceleration devices 106 (e.g., GPUs, FGPAs, ASICs), and/or one or more internal data buses 108 configured to facilitate exchange of data between each hardware component in the compute node. Such components may be affixed to a traditional motherboard, integrated into a system on a chip (SoC), distributed between multiple individual boards/circuits, and/or use any other suitable arrangement.

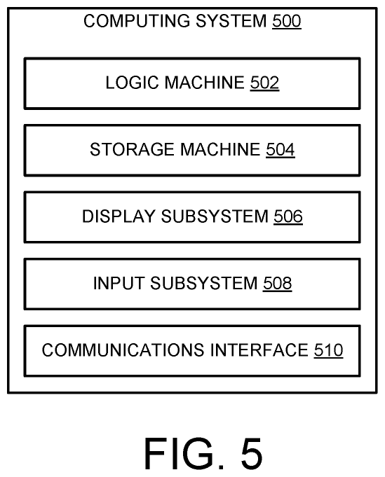

It will be understood that the specific compute nodes 100A-100C shown in FIG. 1 are non-limiting examples. While the term “compute node” is typically used herein to refer to server computers (e.g., traditional or blade servers), the resource disaggregation techniques described herein may be applied to any suitable computing device having any suitable hardware configuration and form factor. In one example, each compute node 100 may be implemented as computing system 500 described below with respect to FIG. 5.

Furthermore, each individual compute node 100 may be configured to perform any of a variety of suitable computing functions, and such functions may be enabled through any combination of software and hardware. For instance, and as will be discussed in more detail below, each individual compute node may in some cases be used to instantiate a plurality of virtual machines, which may be configured and maintained by customers of the data center or another suitable party. Accordingly, resource disaggregation as described herein may be done such that any or all of the compute nodes, as well as any virtual machines (and/or other software functions/resources) implemented on the compute nodes, share access to one or more disaggregated resource pools.

Such disaggregated resource pools are also schematically shown in FIG. 1 as resource pools 110. As examples, resource pools 110 may include data storage hardware, volatile/non-volatile memory, processing acceleration hardware, etc. In various implementations, each different type of pooled resource may be disposed within separate physical housings (e.g., 1U, 2U, 4U server housings), one or more different types of resources may be collocated in a same physical housing, and/or an individual pool of resources may be implemented by one or more different housings/devices working collectively.

It will be understood that any suitable distribution of resources between local compute nodes and disaggregated resource pools may be used. In other words, resource pools such as those shown in FIG. 1 may be used in addition to, or as an alternative to, local hardware resources on each individual compute node. For instance, it may in some cases be desirable for individual compute nodes to retain at least some data storage, memory, and/or processing acceleration hardware even when such resources are abundantly available in disaggregated pools. In an example scenario, each of a plurality of compute nodes may still include at least one local memory device, configured to fulfill at least some of a plurality of memory read requests and memory write requests of each compute node. However, the relative amounts of hardware on each individual compute node may optionally be reduced when disaggregated resource pools are used, which may serve to conserve financial resources and electrical power, simplify compute node design, etc., as compared to conventional approaches. Alternatively, in some examples, each individual compute node may completely omit any hardware resources that are available in shared pools. For example, when one or more pools of acceleration hardware are available, individual compute nodes may forgo local accelerators, instead relying exclusively on the one or more remote pools.

The individual resource pools may have any suitable spatial relationship with respect to each other and with respect to the plurality of compute nodes. In FIG. 1, each of the disaggregated resource pools and compute nodes are shown as being included in compute node cluster 112. This may, for instance, correspond to a single rack in a data center (e.g., a 42U server rack), or another suitable grouping. Furthermore, a data center may include any number of individual racks, clusters, or other groupings, which may in turn include a plurality of compute nodes and one or more disaggregated resource pools.

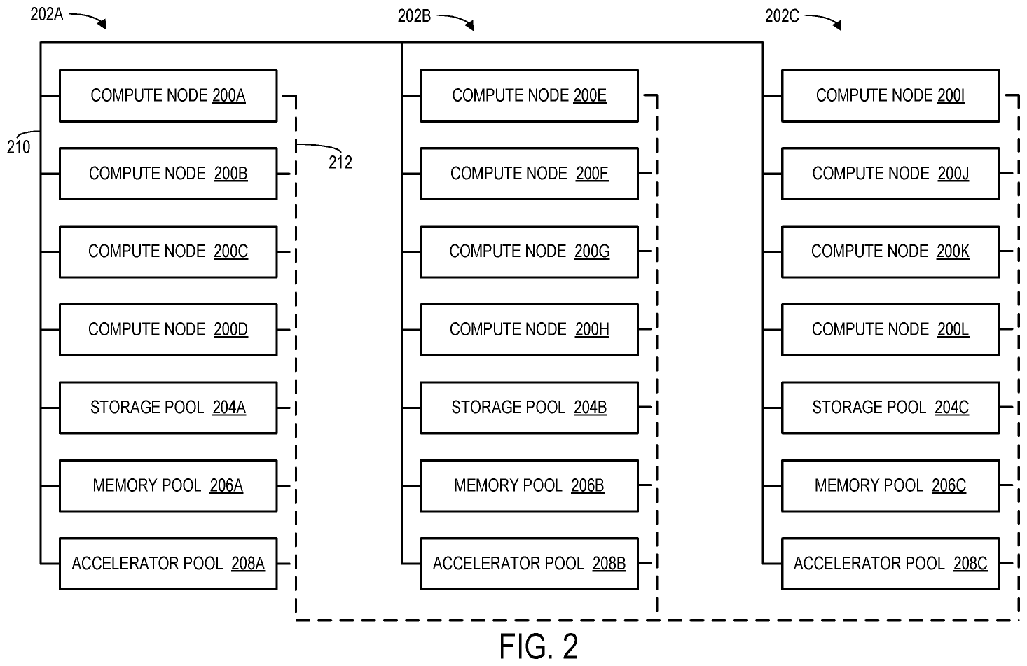

This is schematically shown with respect to FIG. 2. Specifically, FIG. 2 shows a plurality of example compute nodes 200A-200L. Groups of such compute nodes are divided between three different clusters 202A-202C, which again may correspond to individual server racks, rack collections or other suitable groupings. As shown, in addition to the compute nodes 200, each cluster includes a storage pool 204, memory pool 206, and accelerator pool 208. Such resource pools may, as discussed above, be usable by compute nodes in the same and/or different clusters to supplement and/or replace local hardware resources of the compute nodes.

Also shown in FIG. 2 are two data exchange links 210 and 212. Link 210 may, for instance, take the form of one or more conventional networking cables, data buses, and/or other interlinks configured to facilitate communication between computing devices in a data center. For instance, link 210 may facilitate communication between individual compute nodes and a Top of Rack (ToR) switch, Baseboard Management Controller (BMC), circuit breaker, local/remote network interface, etc. By contrast, link 212 may be a backend compute bus configured to facilitate communication between individual compute nodes and the various disaggregated resource pools that the compute nodes utilize. For instance, a CPU physically located within compute node 200A may write data to a memory device (e.g., dynamic random-access memory (DRAM) stick) located within memory pools 206A (and/or memory pools 206B/206C) over link 212.

Links 210 and 212 may be implemented using any suitable cables, connectors, and/or other hardware. As examples, links 210 and 212 may be implemented using Ethernet cables, optical cables, Peripheral Component Interconnect (PCI/PCIe) cables, Gen-Z compliant connectors, Compute Express Link (CXL) compliant connectors, etc. Furthermore, though two different links are shown in FIG. 2, links 210 and 212 may in some cases be consolidated into a single interlink or divided between more than two interlinks. In general, compute nodes and disaggregated resource pools may communicate with one another and/or other devices and systems in any suitable way.

Notably, FIG. 2 illustrates a “rack pooling” model, in which each rack in a data center includes one or more disaggregated resource pools that compute nodes in the rack (and/or compute nodes in other racks) can make use of. Alternatively, however, a variety of suitable topologies may be used. For instance, in a “row pooling” model, a plurality of racks may each include a plurality of compute nodes without including disaggregated resource pools. However, one or more racks may include substantially only disaggregated resource pools usable by compute nodes in each of the other racks.

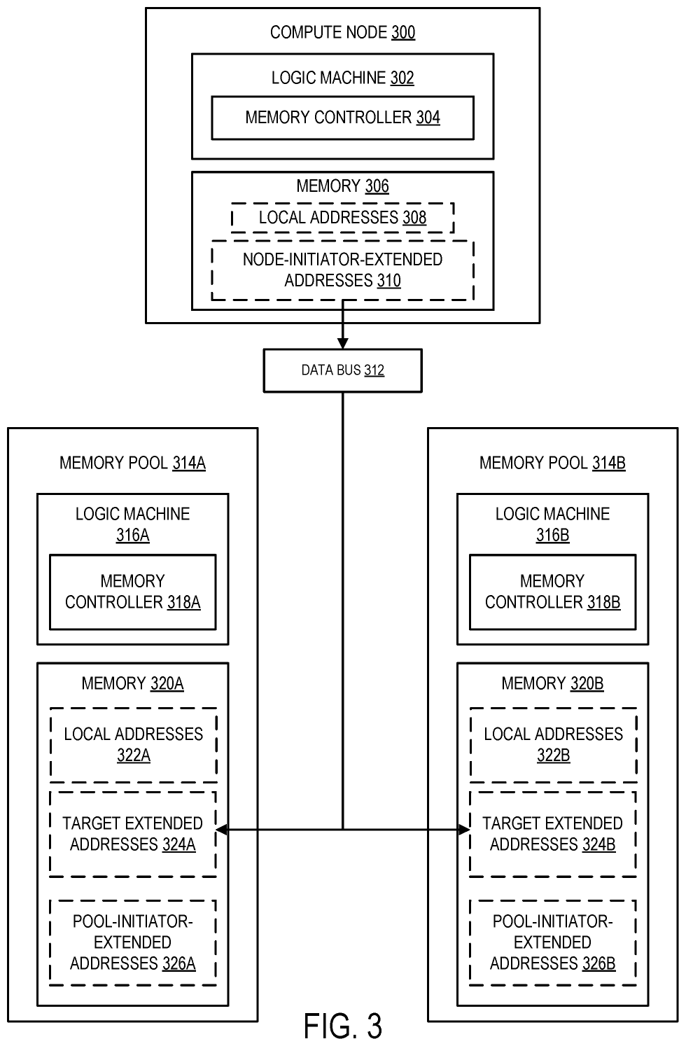

Various details associated with disaggregation of hardware resources will vary depending on the specific type of resource in question. Specific details with regard to disaggregation of memory will now be described with respect to FIG. 3, which shows another example compute node 300. While FIG. 3 only shows a single compute node 300, it will be understood that a pool of memory may be shared between any suitable number of compute nodes, including compute nodes in a same rack/cluster or other grouping as the memory pool, and/or compute nodes in other racks/clusters/groupings.

As shown, compute node 300 includes a logic machine 302. The logic machine may be implemented as any suitable processing componentry, including a CPU, SoC, ASIC, FPGA, etc., and may take the form of logic machine 502 described below with respect to FIG. 5.

Compute node 300 also includes a memory controller 304 configured to manage utilization of memory by the compute node and/or any virtual machines implemented by the compute node. Memory controller 304 may take the form of any suitable chip, combination of chips, set of software/firmware instructions, etc. As one non-limiting example, the memory controller may be implemented as a CXL-compliant memory controller.

Memory controller 304 may be configured to manage utilization of memory 306 of compute node 300. Memory 306 may take any suitable form, including dynamic random-access memory (DRAM), among other suitable technologies. Regardless, however, memory 306 will include a plurality of physical addresses corresponding to locations where data can be stored and retrieved. Such physical addresses may be mapped to a plurality of memory device addresses by memory controller 304. These are shown as local addresses 308, which are addresses mapped to memory 306 and accessible to logic machine 302. In some cases, the memory controller may include an agent (e.g., a home agent) that is assigned to manage and coordinate a set of physical addresses owned by the home agent. The agent may coordinate ownership of physical address changes across memory controllers, such that a page swap from remote memory to local memory would not result in a physical address change. Alternatively, memory controllers may be independently operated, such that ownership of a physical address is locked across memory controllers, and thus a higher-level entity may change the physical address to enable page swaps.

However, compute node 300 also maintains a set of node-initiator-extended addresses 310. These represent physical addresses that are not on memory 306, but rather correspond to addresses on memory located in one or both of memory pools 314A and 314B. As used herein, the term “initiator” refers to a compute node that is making use of a disaggregated resource pool (e.g., storage, memory), while the term “target” refers to a device implementing a pooled resource that is made accessible to and utilized by an initiator.

Communication between initiators (e.g., compute node 300) and targets (e.g., memory pools 314A/B) may take place over a data bus 312 that may, for instance, correspond to data exchange link 212 of FIG. 2, and therefore utilize any suitable technology as discussed above with respect to link 212. Similarly, one or both of memory pools 314A and 314B may correspond to one or more of memory pool 206A, 206B, and 206C of FIG. 2. Links 210 and 212 may be implemented using any suitable cables, connectors, and/or other hardware. As examples, links 210 and 212 may be implemented using Ethernet cables, optical cables, Peripheral Component Interconnect (PCI/PCIe) cables, Gen-Z compliant connectors, Compute Express Link (CXL) compliant connectors, etc. Furthermore, though two different links are shown in FIG. 2, links 210 and 212 may in some cases be consolidated into a single interlink or divided between more than two interlinks. In general, compute nodes and disaggregated resource pools may communicate with one another and/or other devices and systems in any suitable way.

Each disaggregated memory pool 314A/B includes a logic machine 316A/B and memory controller 318A/B, which may be substantially similar to logic machine 302 and memory controller 304 described above. In other words, memory controllers 318A/B may be configured to manage utilization of memory devices of the disaggregated memory pools by compute node 300 (and/or any other compute nodes). Furthermore, memory pools 314A/B each include memory 320A/B, which may be substantially similar to memory 306—e.g., corresponding to some number of discrete Random-Access Memory (RAM) or Storage Class Memory (SCM) devices or similar. As such, addresses of memory 320A/B are mapped by memory controllers 318A/B as a plurality of addresses 322A/B, which are accessible to logic machines 316A/B of memory pools 314A/B.

However, some addresses of memory 320A/B are mapped as target extended addresses 324A/B, which correspond to the node-initiator-extended addresses of compute node 300. In other words, any data written by logic machine 302 to an address falling within the node-initiator-extended addresses 310 may actually be stored at one or both of memory 320A and memory 320B (e.g., one or more discrete memory devices of the disaggregated memory pools) at a target extended address. Furthermore, target extended addresses 324A/B may correspond to node-initiator-extended addresses of a plurality of different compute nodes, meaning any of the plurality of different compute nodes may write data to memory 320A/B in addition to, or instead of, memory locally stored on the different compute nodes.

Notably, disaggregation of memory in this manner may be specified and managed by any suitable device or component. In various examples, support for disaggregation may be provided in software/firmware, such as an operating system component or user-installable application; and/or hardware, such as the logic machine (e.g., SoC), memory controller, etc. In one example scenario, an operating system of the compute node (e.g., a host operating system and/or one or more guest operating systems associated with one or more virtual machines) need not be aware that the node-initiator-extended addresses 310 correspond to physically remote memory. Rather, the operating system may simply generate memory read requests and/or memory write requests that specify a particular address, and the memory controller may fulfill such requests by accessing a corresponding address on remote memory.

Additionally, or alternatively, the operating system may have at least some information regarding performance characteristics of the memory pools. For instance, read/write operations performed on remote memory may have relatively more latency than similar operations performed on local memory. Even if the operating system is not aware that the initiator extended addresses correspond to physically remote memory, the operating system may nonetheless have at least some information regarding latency values and/or other performance characteristics associated with such memory, for instance via a Static Resource Affinity Table (SRAT), Heterogeneous Memory Attribute Table (HMAT), or similar. In this manner, the operating system may optimize storage of data, such that data associated with relatively latency-sensitive operations may be stored on local memory, while less latency-sensitive data may be extended to the disaggregated memory pool. In other words, data having a first latency sensitivity may be stored in the disaggregated memory pool, while data having a second, higher latency sensitivity may be stored in local memory. For instance, the operating system or hardware-assisted logic may be configured to page swap hot/cold memory in initiator local memory to and from target remote memory regardless of whether the operating system is aware that the target remote memory is physically remote, and not simply on-board memory having lower latency.

As discussed above, disaggregation of memory can provide numerous advantages. For instance, when disaggregated memory is available, the amount of memory hardware provided locally on each compute node may be reduced or even eliminated entirely, potentially reducing the overall complexity and price of each compute node. Furthermore, when a compute node logic machine (e.g., 302) detects that its local memory (e.g., 308) has been exhausted, it may opt to leverage disaggregated volatile memory or storage-class memory as extended memory. A suitable hardware controller may move data to/from expanded memory into/from extended memory via suitable caching, paging, or swapping techniques. In one example, individual compute nodes may be constructed having no local memory at all, provided that the disaggregated memory is accessible with a suitable latency. Furthermore, because the disaggregated memory is accessible by a plurality of computing devices, each individual compute node will typically have access to as much memory as it needs, resulting in more efficient memory usage. For instance, some compute nodes tasked with relatively resource-intensive workloads may have access to more overall memory than they ordinarily would if they were limited to only on-board memory, while compute nodes that are sitting idle or are tasked with relatively less-intensive workloads are not monopolizing memory that would otherwise go underutilized.

In general, disaggregating resources as discussed herein has the potential to introduce a single point of failure with a high blast radius, meaning that, for instance, failure of a memory pool can leave a high number of individual compute nodes without access to memory. Thus, in some scenarios, disaggregated resource pools as described herein may be designed to be fault tolerant via various mechanisms. In other words, should an individual device or component fail, reach a performance capacity, be damaged or removed, etc., other devices/components may be configured to adapt accordingly.

For instance, in FIG. 3, two memory pools 314A/B are depicted. Notably, each of the disaggregated memory pools may be disposed in separate housings from one another and from the plurality of compute nodes—e.g., in separate physical housings on a server rack. Should, for example, memory pool 314A suddenly stop responding, any memory read requests or memory write requests that would ordinarily be handled by memory pool 314A may instead be sent to pool 314B. To realize this, each compute node may be configured to automatically detect when its read/write requests are no longer being fulfilled (e.g., at the operating system, SoC, memory controller, or other suitable device/component), and begin sending such requests to a different memory pool. Alternatively, such request switching may be performed by another device disposed between the compute nodes and memory pool, or achieved in another suitable way.

Depending on the specific implementation, a pair of memory pools or expanded memory pools (or other devices) may operate in an “active-active” or “active-passive” configuration. In an “active-active” scenario, each memory pool may primarily serve some collection of compute nodes (e.g., half the nodes in a given rack), while simultaneously serving as a potential backup “active-passive” for some other number of nodes (e.g., the other half). Should one memory pool fail, the remaining pool may begin serving the entire collection of compute nodes.

In an example active-active workflow, a first target (e.g., memory pool 314A) may receive a write request (e.g., referencing a virtual memory address) from an initiator (e.g., compute node 300) and forward the write request to a different target (e.g., memory pool 314B). The first target 314A may send the write request (e.g., referencing a channel address) to an associated memory controller, which may then fulfill the write request, potentially after forwarding the request to a specific memory device in 324A that owns an associated physical address space, and outputs an acknowledgement (ACK) upon completion. At or around the same time, similar steps may be performed by the second target after receiving the write request forwarded by the first target, which after fulfilling the request may output an ACK to the first target. Once a memory controller of the first target receives ACKs indicating that the write request has been fulfilled at both targets, it may output an ACK to the initiator indicating that its write request was fulfilled successfully.

By contrast, in “active-passive” scenarios, one memory pool may be designed as the “primary,” while the other pool operates as a “secondary” or “backup” that is only used upon failure of the primary pool. Thus, any/all data stored by the “active” pool may be copied to the “passive” pool, to prevent data loss and minimize disruption upon failover. In an example active-passive workflow, a first target (e.g., memory pool 314A) may receive a write request from an initiator (e.g., compute node 300). However, in this scenario, the first target does not respond, either due to being offline, damaged, physically removed, or another reason. Thus, after the write request times out, the initiator may instead forward its write request to a second target (e.g., memory pool 314B), which may then perform similar write steps as discussed above, as well as attempt to forward the request to the first target. Should this request also timeout (e.g., because the first target is still offline), then the second target may initiate failover mode operations and output an ACK back to the initiator.

In either of the active-active or active-passive scenarios, interactions between the various targets and initiators may be governed by the devices themselves and/or other suitable devices. For example, in a switch-based replication model, a network switch may forward read/write requests to relevant targets, instead of relying on the targets themselves to forward their own requests to a tandem-paired target.

As another example topology, a hub-and-spoke model may be used. In such cases, an initiator may act as a hub and obtain extended address allocations from multiple targets, acting as spokes. Alternatively, a target may act as a hub that receives extended address space from multiple other targets, acting as spokes, to serve various initiators. Initiators and targets may optionally be dual-purposed to achieve redundant functionality.

To achieve either of the active-active and active-passive configurations described above, in some implementations, each memory pool 314 may be configured to copy at least some data (e.g., via a suitable Redundant Array of Inexpensive Disks or Devices (RAID) protocol or similar) stored on its counterpart pool. In this manner, should one device fail, no data is lost.

Furthermore, in the event that a single initiator or paired target fails, all affected virtual addresses may be evicted to allow for independent operation of other platforms. For example, a fatal Machine Check Architecture (MCA) error on a target may cause all initiators using that target, as well as a paired target, to fault. To reduce the potential blast radius in this scenario, each device may send read/write requests in the form of physical addresses, though such requests may be received as virtual addresses that map to a local physical address space. Furthermore, a target high-level operating system may be configured to truncate memory and reside on a same SoC as the target system to avoid conflicts. Alternatively, the target high-level operating system (HLOS) may reside on an independent target SoC, which may be configured to take fatal MCA events or power-cycle without impacting the various initiators and target extended addresses. Nonetheless, the high-level operating system may continue to perform memory management and diagnostic operations via side-band management channels.

Furthermore, such fault tolerance may facilitate easier maintenance/replacement of various components and devices associated with the disaggregated memory pool. For instance, such devices and components may be “hot-swappable,” such that sudden removal of any given component does not result in failure of adjacent components. In this manner, individual memory sticks/cards, SoC sleds, input/output modules, etc., may be removed for maintenance or replacement without requiring the entire memory pool to be taken offline, which would ordinarily affect performance of the plurality of compute nodes. In some examples, redundant data stored between two or more memory pools may use the same addresses across each pool, further simplifying hot swapping and enabling the ability to service the address request from an alternate device without causing an exception. Although, different memory addresses could be used in some implementations (e.g., tracked in a table maintained at the memory controller or other suitable location).

Designing resource pools to be fault tolerant in this manner can in some cases increase the total amount of resources necessary to provide a baseline level of functionality. For example, when redundant pairs of memory pools each clone data stored on their counterparts as discussed above, the system's overall resilience to failure may increase, although more overall memory hardware may be used as compared to a less-fault-tolerant system. For example, having two redundant memory pools will inherently cost more to procure and maintain than a system that provides an equivalent amount of disaggregated memory with no redundancy.

One potential approach for mitigating this is sometimes referred to as “thin provisioning.” In general, in data center environments, it can be observed that individual compute nodes (and/or virtual machines implemented on the compute nodes) often request or are allocated more resources (e.g., storage space, memory) than the compute nodes end up actually using. For instance, the amount of memory allocated to a particular compute node may be significantly higher than the amount of memory actually utilized by the compute node at any given time. When compounded over a plurality of compute nodes, the amount of allocated but unused memory (or other resources) can represent a significant fraction of the total memory in the data center. Notably, the resource disaggregation techniques described herein may be implemented with or without thin provisioning. In other words, memory disaggregation may occur in “thin” provisioned or “thick” provisioned contexts. Furthermore, both thick and thin provisioning techniques may be used in the same implementation.

Using the example of FIG. 3, memory pools 314A/B may collectively include, for example, 8 TB of total memory, where each of 40 compute nodes are allocated 192 GB of memory. However, it is generally unlikely that every compute node will use its full 192 GB, or even a significant portion of the 192 GB, at any given time. Thus, the 40 individual compute nodes may collectively utilize, for instance, 4 TB in average usage, meaning the memory pool has approximately 50% unused capacity.

Given this, the amount of memory actually available in the memory pool could be reduced without affecting significant performance of the plurality of compute nodes. For instance, each of the plurality of compute nodes could be allocated an address range for 192 GB remote memory in addition to 64 GB local memory, resulting in leveraging 10 TB of total allocated memory. However, the memory pool could be constructed such that it only has a total of 2 TB, meaning the amount of allocated memory exceeds the amount of memory that actually exists. To address this, each particular compute node may have 256 GB, although the majority of that memory is not actually used by the compute node, and therefore may additionally be allocated for one or more additional compute nodes. In this manner, any particular compute node has the option to use up to 256 GB if needed, while still conserving memory in the disaggregated pool, due to the fact that each compute node typically will not use 256 GB at any given time.

Such thin provisioning may be done to any suitable extent. As used herein, “thin provisioning” applies to any scenario in which the total amount of any particular resource (whether that resource is data storage space, memory, or another suitable resource) that is allocated for use exceeds the amount of the resource that is actually available for use. Continuing with the memory example, it is generally beneficial for the amount of available memory to exceed the amount of memory typically used by the plurality of compute nodes under typical circumstances. In other words, if the compute nodes typically use around 256 GB, then it is generally desirable to have more than 256 GB of memory actually available, such that the compute nodes do not exhaust the available memory during normal use. In practice, however, any suitable amount of memory may be available in the disaggregated memory pool, which may have any suitable relationship with the amount of memory allocated to the plurality of compute nodes.

Notably, thin provisioning has been discussed herein as a potential technique for mitigating increased resource costs associated with fault tolerance. However, it will be understood that resource disaggregation, fault tolerance, and thin provisioning can each be implemented independently. In other words, a disaggregated resource pool may be thin provisioned without implementing the fault tolerance techniques discussed above, and similarly such a resource pool may utilize fault tolerance without thin provisioning.

Logic associated with implementing thin provisioning may be disposed at any suitable hardware device. As two non-limiting examples, thin provisioning could be governed by the initiator memory controllers and/or the target memory controllers. In other words, each initiator may or may not be aware that the target memory devices are thin provisioned. In some cases, it may be beneficial for thin provisioning to be governed by target memory controllers, as it may be relatively more complicated to configure a relatively high number of initiators to perform thin provisioning, as opposed to a relatively smaller (e.g., 40:1) number of targets.

To further illustrate the concept of thin provisioning, an example scenario will be presented in which the following assumptions are used:

Initiators=40 (up to 64)=6 bits

Initiator EA (extended address) Offset=256 GB=38 bits

Target EA Offset=4 TB=42 bits

Target Dirty Bit=1 bit

Target Replication Bit=1 bit

TABLE 1

| Initiator | Target | | | |
|---|---|---|---|---|
| ID | Offset | Offset | Dirty | Replication |
| 6 | 38 | 42 | 1 | 1 |

In the above example, a total of 44 bits can be used to address all 64 initiators' memory, in which each initiator is given 256 GB of EA space. While it is possible to map all possible initiator address space to the target, it may be more beneficial to map (at runtime) the target address space needed to the initiator. In this manner the total address space that can be given to the initiator is practically unlimited.

A simple translation table would ingest an initiator's 44 bits and map it to 44 bits of target memory. However, if the granularity of each page size is 4K then the total in memory footprint of the translation table is 11 GB.

Row Entries=1,073,741,824=4,398,046,511,104 bytes/4096 bytes

Row Size=11 bytes=88 bits

Total Memory Footprint=11,264 MB=11 bytes*1,073,741,824 row entries

Despite mapping the target offset (instead of initiator offset), a 11 GB (max size) thin provisioning translation table may in some cases be too large. As a result, spatial mapping may be used in which chunks (AKA slices) greater than 4K are allocated while maintaining 4K page transactions. This allows the initiator's address to fall within chunks. For example, if 1 MB chucks are used then the memory footprint drops to 44 MB.

Row Entries=4,194,304=4,194,304 MB/1 MB chunks

Row Size=11 bytes=88 bits

Total Memory Footprint=44 MB=11 bytes*4,194,304 row entries

While this solves for the total memory footprint of the table it generates a new problem. When memory is freed from use, and a table entry or row needs to be removed, the dirty bit is now tracking each chuck instead of 4K page, and therefore cannot track 4K page release operations. This can be solved by writing all zeros to the freed 4K page followed by garbage collection when all 4K pages within the chunk are zero. This doubles as a security measure to ensure the next tenant of this chunk cannot see the previous tenant's data. In the event a tenant willfully writes all Os to full chucks (which is deallocated during garbage collection), and subsequently requests a read the translation table will not have a row entry. This can be mitigated by returning all Os by default when a table entry is not found. This should not be confused with translation table conflicts where two rows have the same lookup value. While this generally should not occur, a hash may need to be generated to avoid conflicts.

This thin provisioning methodology can be applied at a hardware level. For example, memory controllers may be configured to translate physical addresses to memory addresses (removing interim channel addresses for simplicity) by leveraging memory address bits matrixed across DIMMs, banks, rows, and columns. This functionality can be used to keep the translation table in the memory controller while translating directly to the target memory address device (instead of target physical address space). Consider the following assumptions for the target side with 2X 2 TB main memory:

# of DIMMs=2=1 bit

# of Bank Groups=2=1 bit

Bank Group Address=2=1 bits

Bank Address (per BG)=4=2 bits

Rows Address (per Bank)=131,072=17 bits

Columns Address (per Bank)=1024=10 bits

Page Size=1 MB (chunks)=10 bits

Total=4 TB=42 bits

Therefore, when leveraging a memory controller, the final translation table may resemble table 2 below, in which the 42 address bits are repurposed for thin provisioning translation.

TABLE 2

| | | Target (Memory Controller) | | | | | | | | |
|---|---|---|---|---|---|---|---|---|---|---|
| Initiator | | # of | # of | | | | Col- | | | Repli- |
| ID | Offset | Dimm | BG | BG | Bank | Row | umn | Page | Dirty | cation |
| 6 | 38 | 1 | 1 | 1 | 2 | 17 | 10 | 10 | 1 | 1 |

Modern memory controllers can offer additional capabilities that enable new use cases. With the onset and exploration of shared memory controllers, two controllers can work in tandem as one to enable a replicated system. This solution draws numerous parallels to a RAID controller functionality with SSDs. By leveraging thin provisioning translation tables, memory disaggregation can be achieved in a manner that is both cost-effective and provides high availability.

When thin provisioning is used, there is a chance that, at any point in time, the plurality of compute nodes may attempt to use more memory than is actually available. For instance, a relatively high number of compute nodes may each attempt to use a greater portion of their allocated memory than is typical, thereby reaching the capacity of the disaggregated memory pool. This may be handled in various ways depending on the implementation. In one example approach, multiple memory tiers may be used having varying capacity and latency characteristics. Thus, when a particular memory tier is fully utilized, additional data may be stored in higher-latency tiers.

Thin provisioning may be more effective when the amount of data to be stored in memory is reduced, thereby further reducing the minimum amount of memory hardware required by the system. Thus, thin provisioning may be implemented along with data compression, deduping, mirroring, erasure encoding, and/or other similar techniques to further reduce the amount of data to be stored.

In another example, if the capacity of a particular memory pool has been reached, additional write requests may be forwarded to alternative memory pools (e.g., associated with a different server rack, cluster, or other grouping), which may have remaining unused memory, although may respond with a higher latency. For example, as discussed above, node-initiator-extended addresses 310 of compute node 300 correspond to physical addresses (PA) on memory 320A/B located in memory pools 314A/B. However, as shown, each of memory pools 314A/B also maintain sets of pool-initiator-extended addresses 326A/B, which similarly correspond to physical addresses on memory that are located on other memory pools. In other words, in addition to serving as targets for one or more compute node initiators, each memory pool may in turn act as an initiator that is serviced by one or more different memory pools.

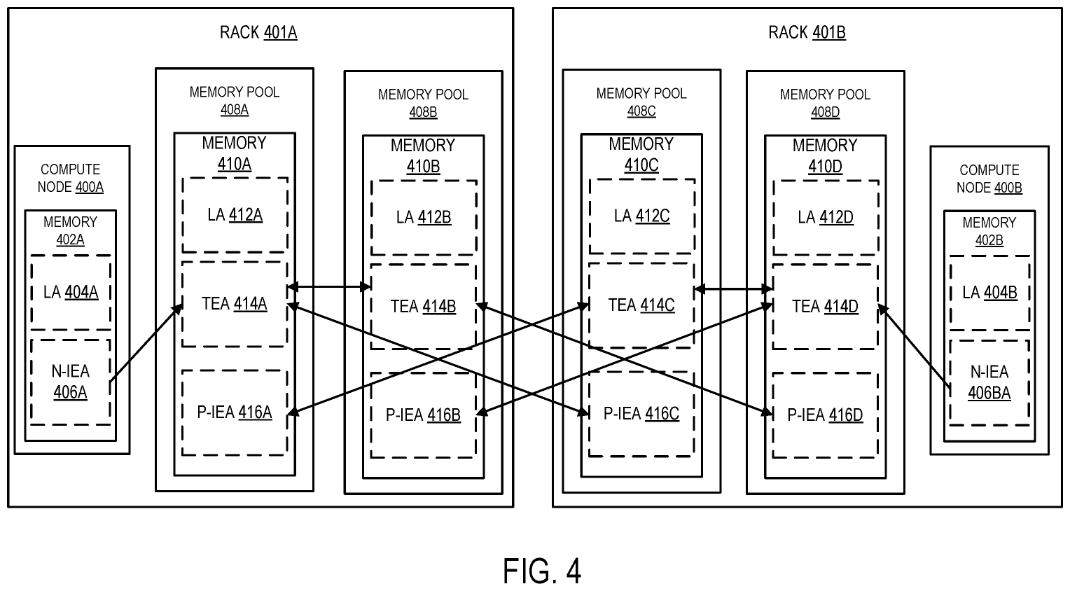

This is illustrated in FIG. 4, which schematically shows additional example compute nodes 400A/B, as well as memory pools 408A-D. Notably, compute node 400A and memory pools 408A and 408B are each located on a first server rack 401A, while compute node 400B and memory pools 408C and 408D are each located on a second server rack 401B. This is intended to illustrate the fact that communication may occur between various compute nodes, disaggregated resource pools, and other suitable devices regardless of whether such devices are located on the same or different server racks, or otherwise part of the same general grouping or cluster.

As shown, each of compute nodes 400A and 400B include memory 402A/B, local addresses 404A/B, and node-initiator-extended addresses 406A/B, which may function substantially as discussed above with respect to FIG. 3. Furthermore, each of memory pools 408A-D include respective volatile memories 410A-D, local addresses 412A-D, and target extended addresses 414A-D. Thus, data written by compute node 400A to an initiator extended address 406A is stored on memory 410A at a target extended address 414A. Furthermore, as discussed above, some amount of stored data may in some cases be cloned, replicated, and/or otherwise duplicated between various memory pools. Thus, as shown, data stored at various target extended addresses may be copied to the same or different target extended addresses of a different memory pool (e.g. 414A/C or 414C/D).

Furthermore, each memory pool 408 maintains a set of pool-initiator-extended addresses 416, which reference data stored at target extended addresses 414 of other memory pools. For instance, compute node 400A may write data to a node-initiator-extended address 406A, which may ordinarily be stored at a target extended address of memory pool 408A. However, depending on various factors including latency, available capacity, etc., memory pool 408A may opt to write the data to a pool-initiator-extended address 416A, which may result in the data actually being stored at a target extended address 414B, 414C, and/or 414D. In this manner, a plurality of memory pools may collectively implement a nested memory hierarchy, in which memory pools can serve as both targets and initiators at any given time. This enables a variety of architectural models based on the need (e.g., peer-to-peer, matrix, rack/row, hub/spoke, daisy chain, etc.).

Use of a disaggregated memory pool can provide myriad advantages, including advantages not explicitly discussed herein. For instance, as discussed above, compute nodes in a data center are often used to instantiate one or more virtual machines, which can be applied to computational workloads without being tied to any particular compute node. As such, migration of virtual machines from one compute node to another is a relatively common operation depending on availability, performance considerations, etc. Such migration can be a sensitive process, as any errors that arise when moving data from one node to another can crash software applications, disrupting functionality. This can be partially alleviated through use of disaggregated memory pools as discussed herein, as much of the data associated with running operations may already be stored in a shared memory pool, as opposed to being confined to memory physically located in the same housing as the original compute node. Thus, rather than having to move the data from a first compute node to a second compute node, the second compute node may simply be notified where the relevant data is stored, resulting in a more efficient and less error-prone migration.

Furthermore, any virtual machines implemented by a compute node may be treated as independent computing devices from the standpoint of memory disaggregation. In other words, a particular compute node may implement two or more virtual machines. A disaggregated memory pool may then be configured to fulfill any or all memory read requests and write requests generated by the two or more virtual machines at any of the plurality of memory devices of the disaggregated memory pool.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 5 schematically shows a non-limiting embodiment of a computing system 500 that can enact one or more of the methods and processes described above. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phone), and/or other computing devices.

Computing system 500 includes a logic machine 502 and a storage machine 504. Computing system 500 may optionally include a display subsystem 506, input subsystem 508, communication subsystem 510, and/or other components not shown in FIG. 5.

Logic machine 502 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 504 includes one or more physical devices configured to hold instructions executable by the logic machine to implement the methods and processes described herein. When such methods and processes are implemented, the state of storage machine 504 may be transformed—e.g., to hold different data.

Storage machine 504 may include removable and/or built-in devices. Storage machine 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 504 may include volatile, nonvolatile, dynamic, static, read/write, read-only, random-access, sequential-access, location-addressable, file-addressable, and/or content-addressable devices.

It will be appreciated that storage machine 504 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 502 and storage machine 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 implemented to perform a particular function. In some cases, a module, program, or engine may be instantiated via logic machine 502 executing instructions held by storage machine 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 506 may be used to present a visual representation of data held by storage machine 504. This visual representation may take the form of a graphical user interface (GUI). As the herein described methods and processes change the data held by the storage machine, and thus transform the state of the storage machine, the state of display subsystem 506 may likewise be transformed to visually represent changes in the underlying data. Display subsystem 506 may include one or more display devices utilizing virtually any type of technology. Such display devices may be combined with logic machine 502 and/or storage machine 504 in a shared enclosure, or such display devices may be peripheral display devices.

When included, input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the Internet.

In an example, a disaggregated memory system comprises: a plurality of compute nodes, each particular compute node of the plurality including at least one local memory device configured to fulfill at least some of a plurality of memory read requests and memory write requests generated by the particular compute node; and a disaggregated memory pool including a plurality of memory devices that are physically separate from the plurality of compute nodes, the disaggregated memory pool communicatively coupled with the plurality of compute nodes, such that the disaggregated memory pool is configured to supplement the at least one local memory device of each of the plurality of compute nodes by fulfilling at least some of the plurality of memory read requests and memory write requests generated by each of the plurality of compute nodes at any particular memory device of the disaggregated memory pool, where an amount of memory collectively allocated to each of the plurality of compute nodes exceeds an amount of memory collectively provided by the plurality of memory devices. In this example or any other example, the plurality of memory devices of the disaggregated memory pool includes volatile memory devices. In this example or any other example, the volatile memory devices include Dynamic Random-Access Memory (DRAM) devices. In this example or any other example, the plurality of memory devices of the disaggregated memory pool includes non-volatile memory devices. In this example or any other example, at least one of the compute nodes of the plurality is configured to implement two or more virtual machines or virtual machine hosts, and the disaggregated memory pool is configured to fulfill any or all memory read requests and memory write requests generated by the two or more virtual machines or virtual machine hosts at any of the plurality of memory devices of the disaggregated memory pool. In this example or any other example, each compute node of the plurality includes a memory controller configured to manage utilization of local and disaggregated memory devices by the compute node. In this example or any other example, the memory controller for each compute node maintains a set of local memory addresses and a set of node-initiator-extended addresses for the compute node, where data written to a local memory address is stored on the at least one local memory device corresponding to the compute node, and where data written to a node-initiator-extended address is stored on one or more of the plurality of memory devices of the disaggregated memory pool. In this example or any other example, the disaggregated memory pool includes a memory controller configured to manage utilization of the plurality of memory devices by the plurality of compute nodes. In this example or any other example, the sets of node-initiator-extended addresses of each compute node of the plurality correspond to a set of target extended addresses maintained by the memory controller of the disaggregated memory pool, such that data written by a particular compute node to a particular node-initiator-extended address is stored at a corresponding target extended address on a particular memory device of the disaggregated memory pool. In this example or any other example, the disaggregated memory system further comprises a second disaggregated memory pool including a second plurality of memory devices, where at least some data stored by the plurality of memory devices of the disaggregated memory pool is copied to the second plurality of memory devices of the second disaggregated memory pool. In this example or any other example, the second plurality of memory devices of the second disaggregated memory pool are each physically separate from the plurality of compute nodes. In this example or any other example, each of the plurality of compute nodes is configured to, upon determining that the disaggregated memory pool is offline, send some or all of their memory read requests and memory write requests to the second disaggregated memory pool. In this example or any other example, the memory controller for the disaggregated memory pool further maintains a set of pool-initiator-extended addresses, and where data written to a pool-initiator-extended address is stored on one or more of the second plurality of memory devices of the second disaggregated memory pool. In this example or any other example, each compute node of the plurality is configured to write data having a first latency sensitivity to node-initiator-extended addresses, and write data having a second, higher latency sensitivity to local addresses or a local memory cache. In this example or any other example, the plurality of compute nodes are server computers and are stored on a server rack. In this example or any other example, the plurality of memory devices of the disaggregated memory pool are disposed within one or more server computer housings also stored on the server rack.

In an example, a disaggregated volatile memory system comprises: a plurality of compute nodes; and a disaggregated volatile memory pool including a plurality of volatile memory devices each physically separate from the plurality of compute nodes, the disaggregated volatile memory pool communicatively coupled with the plurality of compute nodes, such that the disaggregated volatile memory pool is configured to fulfill, at any particular volatile memory device of the disaggregated volatile memory pool, at least some of a plurality of memory read requests and memory write requests of each of the plurality of compute nodes, where an amount of volatile memory collectively allocated to each of the plurality of compute nodes exceeds an amount of volatile memory collectively provided by the plurality of volatile memory devices. In this example or any other example, the volatile memory devices include Dynamic Random-Access Memory (DRAM) devices. In this example or any other example, the disaggregated volatile memory system further comprises a second disaggregated volatile memory pool including a second plurality of volatile memory devices, where at least some data stored by the plurality of volatile memory devices of the disaggregated volatile memory pool is copied to the second plurality of volatile memory devices of the second disaggregated volatile memory pool.

In an example, a disaggregated volatile memory system comprises: a plurality of server computers stored on a server rack, each particular server computer of the plurality including at least one local volatile memory device configured to fulfill at least some of a plurality of memory read requests and memory write requests for the particular server computer; and a disaggregated volatile memory pool including a plurality of volatile memory devices each physically separate from the plurality of server computers and also stored on the server rack, the disaggregated volatile memory pool communicatively coupled with the plurality of server computers, such that the disaggregated volatile memory pool is configured to supplement the at least one local volatile memory device of each of the plurality of server computers by fulfilling at least some of the plurality of memory read requests and memory write requests of each of the plurality of server computers at any particular volatile memory device of the disaggregated volatile memory pool, where an amount of volatile memory collectively allocated to each of the plurality of server computers exceeds an amount of volatile memory collectively provided by the plurality of volatile memory devices.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A disaggregated memory system, comprising:
a plurality of compute nodes, each particular compute node of the plurality including at least one local memory device configured to fulfill at least some of a plurality of memory read requests and memory write requests generated by the particular compute node; and
a disaggregated memory pool including a plurality of memory devices that are physically separate from the plurality of compute nodes, the disaggregated memory pool communicatively coupled with the plurality of compute nodes, such that the disaggregated memory pool is configured to supplement the at least one local memory device of each of the plurality of compute nodes by fulfilling at least some of the plurality of memory read requests and memory write requests generated by each of the plurality of compute nodes at any particular memory device of the disaggregated memory pool, where an amount of memory collectively allocated to each of the plurality of compute nodes exceeds an amount of memory collectively provided by the plurality of memory devices.

2. The disaggregated memory system of claim 1, where the plurality of memory devices of the disaggregated memory pool includes volatile memory devices.

3. The disaggregated memory system of claim 2, where the volatile memory devices include Dynamic Random-Access Memory (DRAM) devices.

4. The disaggregated memory system of claim 1, where the plurality of memory devices of the disaggregated memory pool includes non-volatile memory devices.

5. The disaggregated memory system of claim 1, where at least one of the compute nodes of the plurality is configured to implement two or more virtual machines or virtual machine hosts, and the disaggregated memory pool is configured to fulfill any or all memory read requests and memory write requests generated by the two or more virtual machines or virtual machine hosts at any of the plurality of memory devices of the disaggregated memory pool.

6. The disaggregated memory system of claim 1, where each compute node of the plurality includes a memory controller configured to manage utilization of local and disaggregated memory devices by the compute node.

7. The disaggregated memory system of claim 6, where the memory controller for each compute node maintains a set of local memory addresses and a set of node-initiator-extended addresses for the compute node, where data written to a local memory address is stored on the at least one local memory device corresponding to the compute node, and where data written to a node-initiator-extended address is stored on one or more of the plurality of memory devices of the disaggregated memory pool.

8. The disaggregated memory system of claim 7, where the disaggregated memory pool includes a memory controller configured to manage utilization of the plurality of memory devices by the plurality of compute nodes.

9. The disaggregated memory system of claim 8, where the sets of node-initiator-extended addresses of each compute node of the plurality correspond to a set of target extended addresses maintained by the memory controller of the disaggregated memory pool, such that data written by a particular compute node to a particular node-initiator-extended address is stored at a corresponding target extended address on a particular memory device of the disaggregated memory pool.

10. The disaggregated memory system of claim 9, further comprising a second disaggregated memory pool including a second plurality of memory devices, where at least some data stored by the plurality of memory devices of the disaggregated memory pool is copied to the second plurality of memory devices of the second disaggregated memory pool.

11. The disaggregated memory system of claim 10, where the second plurality of memory devices of the second disaggregated memory pool are each physically separate from the plurality of compute nodes.

12. The disaggregated memory system of claim 10, where each of the plurality of compute nodes is configured to, upon determining that the disaggregated memory pool is offline, send some or all of their memory read requests and memory write requests to the second disaggregated memory pool.

13. The disaggregated memory system of claim 10, where the memory controller for the disaggregated memory pool further maintains a set of pool-initiator-extended addresses, and where data written to a pool-initiator-extended address is stored on one or more of the second plurality of memory devices of the second disaggregated memory pool.

14. The disaggregated memory system of claim 7, where each compute node of the plurality is configured to write data having a first latency sensitivity to node-initiator-extended addresses, and write data having a second, higher latency sensitivity to local addresses or a local memory cache.

15. The disaggregated memory system of claim 1, where the plurality of compute nodes are server computers and are stored on a server rack.

16. The disaggregated memory system of claim 15, where the plurality of memory devices of the disaggregated memory pool are disposed within one or more server computer housings also stored on the server rack.

17. A disaggregated volatile memory system, comprising:
a plurality of compute nodes; and
a disaggregated volatile memory pool including a plurality of volatile memory devices each physically separate from the plurality of compute nodes, the disaggregated volatile memory pool communicatively coupled with the plurality of compute nodes, such that the disaggregated volatile memory pool is configured to fulfill, at any particular volatile memory device of the disaggregated volatile memory pool, at least some of a plurality of memory read requests and memory write requests of each of the plurality of compute nodes, where an amount of volatile memory collectively allocated to each of the plurality of compute nodes exceeds an amount of volatile memory collectively provided by the plurality of volatile memory devices.

18. The disaggregated volatile memory system of claim 17, where the volatile memory devices include Dynamic Random-Access Memory (DRAM) devices.

19. The disaggregated volatile memory system of claim 17, further comprising a second disaggregated volatile memory pool including a second plurality of volatile memory devices, where at least some data stored by the plurality of volatile memory devices of the disaggregated volatile memory pool is copied to the second plurality of volatile memory devices of the second disaggregated volatile memory pool.

20. A disaggregated volatile memory system, comprising:
a plurality of server computers stored on a server rack, each particular server computer of the plurality including at least one local volatile memory device configured to fulfill at least some of a plurality of memory read requests and memory write requests for the particular server computer; and
a disaggregated volatile memory pool including a plurality of volatile memory devices each physically separate from the plurality of server computers and also stored on the server rack, the disaggregated volatile memory pool communicatively coupled with the plurality of server computers, such that the disaggregated volatile memory pool is configured to supplement the at least one local volatile memory device of each of the plurality of server computers by fulfilling at least some of the plurality of memory read requests and memory write requests of each of the plurality of server computers at any particular volatile memory device of the disaggregated volatile memory pool, where an amount of volatile memory collectively allocated to each of the plurality of server computers exceeds an amount of volatile memory collectively provided by the plurality of volatile memory devices.
